(19) United States
(12) Patent Application Publication
(10) Pub. No.: US 2004/0038645 A1
(43) Pub. Date: Feb. 26, 2004

(54) Carrier sensing multiple access with collision avoidance (CSMA/CA) scheme optimized for a priori known carrier usage for low duty cycle systems

(76) Inventors: Jukka Rcunamaki, Tampere (FI); Juha Salokannel, Kangasala (FI); Antti Lappetelainen, Espoo (FI); Visa Tapio Smolander, Oulu (FI)

Correspondence Address: MORGAN & FINNEGAN, L.L.P., 345 Park Avenue, New York, NY, 10154-0053, US

(21) Appl. No.: 10/224,768

(22) Filed: Aug. 20, 2002

(51) Int. Cl. H04B 5/00

(52) U.S. Cl. 455/41.2; 455/67.11

(57) ABSTRACT

Systems and methods for a communication system implementing a short range communication link between devices advertising available information and services, and user devices which may initiate a request for further information or services. The communication system provides a low power solution utilizing an optimized combination of a carrier sensing and frequency division multiple access to avoid collisions. The optimization involves the use of a random mean zero value offset appended to the advertising devices' transmission frames. The offset increases the likelihood that a first advertising device will recognize the transmissions of another advertiser's transmissions (i.e., determining that a channel is busy) and avoid unnecessary transmissions that will result in collisions. Upon recognition, the first advertiser may shift its transmission frame accordingly, thereby avoiding transmission collisions between advertisers. The communication system may be implemented in either a StandAlone LowRate system, or in a device with a pre-existing operational Bluetooth implementation.

### FIELD OF INVENTION

This invention relates generally to wireless communications systems and more particularly, to the optimization of a short range wireless communications system.

### BACKGROUND INFORMATION

Wireless devices that transmit within a certain operating proximity may experience transmission collisions if the transmissions of each device are sent at substantively the same time and on the same channel. The resulting collisions are unintelligible by receiver devices and contribute to inefficient power consumption in the transmitting device. Implementation of carrier sensing multiple access with collision detection (CSMA/CD) or collision avoidance (CSMA/CA) involves two methods of addressing transmission timing issues. However, in the implementations of the carrier sensing associated with CSMA/CD and CSMA/CA, the success rate of detecting other devices within a predetermined transmission/reception range may be improved. Additionally, the device connection/setup times associated with the devices implementing these protocols is less than ideal.

### SUMMARY OF THE INVENTION

The present invention is directed to systems and methods for implementing a short range wireless communication system.

An exemplary method for implementing a short range wireless communication system, that comprises measuring an energy level on a channel at a time offset from a periodic interval and comparing a measured value of the energy level to a transmission threshold to determine whether to transmit on the channel.

In an alternate embodiment, an exemplary method for implementing a short range wireless communication system, comprises conducting carrier sensing on a channel, wherein the carrier sensing incorporates a random zero mean value offset. Also, if an energy level measured during carrier sensing is below a predetermined threshold, transmitting a message on the channel.

In a further alternate embodiment, an exemplary method for a short range wireless device to communicate on a communication link comprises after establishing a communication link on an initialization channel, tuning from an initialization channel to a unicast channel. Another aspect of the method includes reestablishing the communication link on the initialization channel in the event of a data transmission error in the first packet on the unicast channel. Reestablishing the communication link comprises selecting a random number from an initial range of values, wherein the random number corresponds to a number of wait time periods a receiving device will wait before attempting to reestablish a connection. After a value is selected, the method includes waiting for a length of time equal to the number of wait time periods. The method handles the event in which the receiving device, after waiting the length of time, does not receive an expected transmission, and accordingly increases an upper bound of the initial range.

Thus, in order to avoid possible collisions and conserve power, an optimized version of Carrier Sensing Multiple Access with Collision Avoidance is provided. In particular, in one embodiment, a random mean zero value offset is appended to the start of carrier sensing at the beginning of a transmission frame to increase the likelihood that transmitters within a transmission range will recognize one another's overlapping transmissions and shift their transmission frames to avoid collisions. The transmitters thereby increase the transmission success rate and reduce the connection setup time.

Other and further aspects of the present invention will become apparent during the course of the following description and by reference to the attached drawings.

### BRIEF DESCRIPTION OF THE DRAWINGS

FIG. 1 is a block diagram illustrating a LowRate Service Advertiser device establishing a short range communication link with a LowRate Initiator device.

FIG. 2 illustrates two exemplary message packets for use in an embodiment of the present invention.

FIG. 3A illustrates an exemplary operating frequency spectrum for an implementation of an embodiment of the present invention.

FIG. 3B is a table illustrating an exemplary assignment of operating channels for use in one embodiment of the present invention.

FIG. 4 is a table illustrating an exemplary relationship between the LowRate device transmission power and the transmission interval for an embodiment of the present invention.

FIG. 5 is an exemplary operation diagram of an embodiment of the present invention.

FIG. 6A illustrates an exemplary operation topology for a StandAlone LowRate device.

FIG. 6B illustrates an exemplary operation topology for a DualMode LowRate device.

FIG. 7A illustrates an exemplary use of a random mean zero value offset with carrier sensing when a first device is detected by a second device in one embodiment of the present invention.

FIG. 7B illustrates an exemplary use of a random mean zero value offset with carrier sensing when a first device detects a second device in an alternate embodiment of the present invention.

FIG. 8 illustrates an exemplary use of a random mean zero value offset with carrier sensing in which a first device is detected by a second device which, in turn, cycles through alternate Initialization channels.

FIG. 9 illustrates an exemplary use of a random mean zero value offset with carrier sensing in which a first device is detected by a second device which, in turn, enters a continuous scan mode.

FIG. 10 is a flow chart illustrating an exemplary method by which collision handling may be performed in accordance with one embodiment of the present invention.

### DETAILED DESCRIPTION OF THE INVENTION

In the following description of the various embodiments, reference is made to the accompanying drawings which form a part hereof, and in which is shown by way of illustration various embodiments in which the invention may be practiced. It is to be understood that other embodiments may be utilized and structural and functional modifications may be made without departing from the scope of the present invention.

Overview

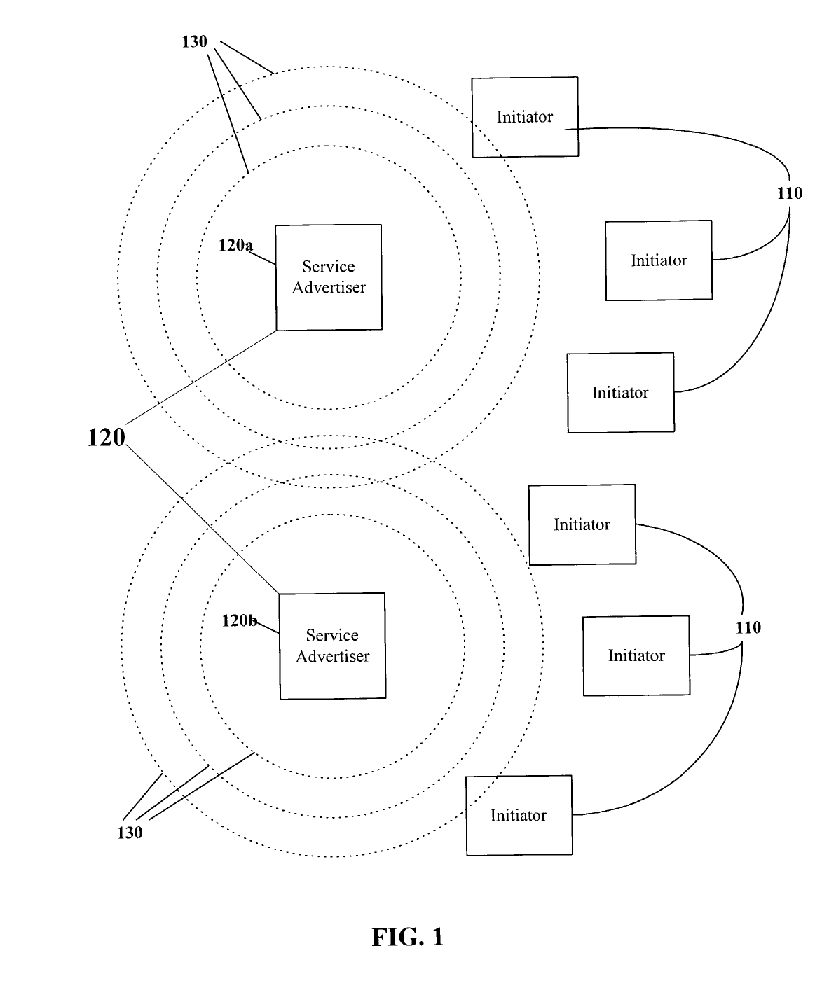

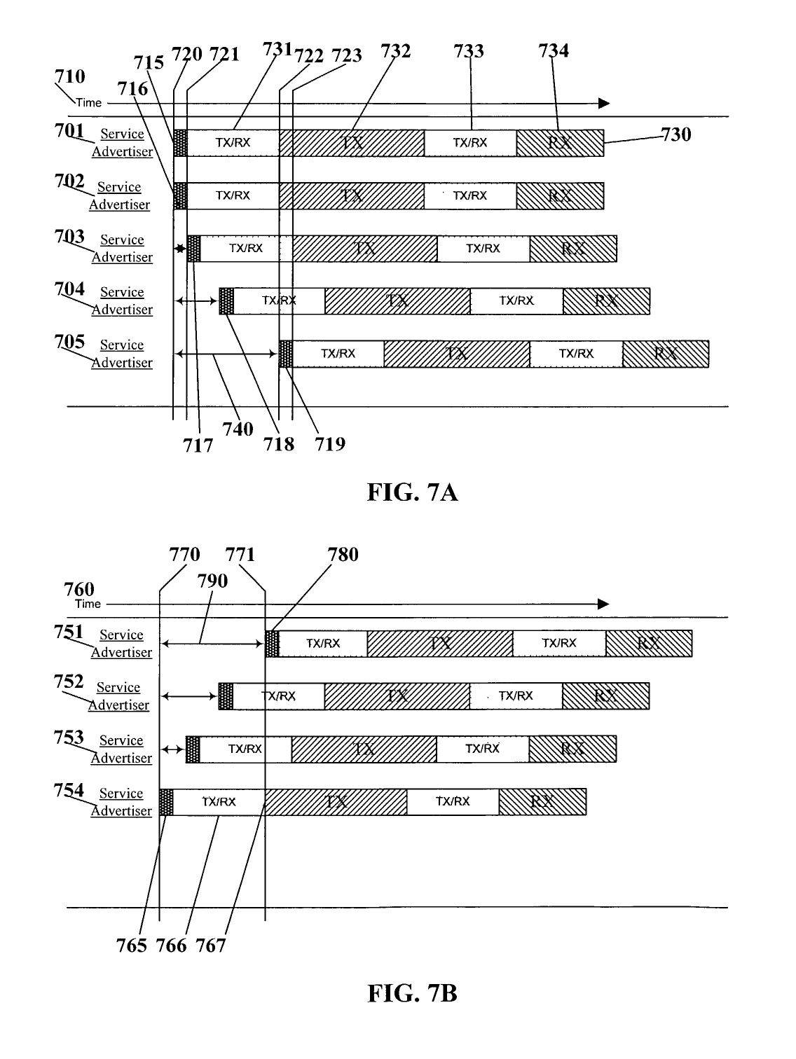

The present invention is directed to a LowRate protocol and the methods and systems for providing low power consumption with optimized collision avoidance for a short range wireless communication system enabling communication between Service Advertiser devices and Initiator devices. LowRate refers to the low power consumption parameters associated with devices implementing the LowRate protocol as compared to a typical Bluetooth device. FIG. 1 is an exemplary embodiment of the present invention wherein one or more of a multiplicity of LowRate Initiator devices 110 establishes a communication link with a LowRate Service Advertiser device 120. The Service Advertiser 120 may be, e.g., a banner advertisement located on a public thoroughfare broadcasting advertisements that inform the Initiator devices 110 within a given coverage area of the availability of additional data or advertised services. A first Service Advertiser 120a begins transmitting on a primary Initialization channel. If another Service Advertiser 120b is already transmitting on the primary Initialization channel as determined by the first Service Advertiser 120a through carrier sensing, the second Service Advertiser 120b will execute a predetermined number of transmission reattempts after a delay between attempts. If after the predetermined number of reattempts the primary Initialization channel is still determined to be congested, transmission reattempts with carrier sensing may be executed on an alternate channel. In order to increase the likelihood that a first Service Advertiser 120a using carrier sensing will recognize that a second Service Advertiser 120b is transmitting simultaneously on the Initialization channel, the first Service Advertiser 120a will append a random mean zero value offset time to the start of the carrier sensing mode in a transmission frame. The offset allows for devices with similar transmission frames to shift their carrier sensing to increase the likelihood that a first Service Advertiser 120a will be conducting carrier sensing while a second Service Advertiser 120b is transmitting on an Initialization channel. The limits of the random mean offset time value distribution are optimized according to system properties. While increasing the offset value from zero, the possibility of detecting other devices increases. However, increasing the offset value greater then Transmit/Receive switching period decreases system capacity. Thus, the Transmit/Receive switching time is the optimal maximum time value for the random mean offset (FIGS. 7A, 7B, 8 and 9). If carrier sensing determines that a second Service Advertiser 120b is already transmitting on an Initialization channel, the channel is designated as BUSY, and the first Service Advertiser 120a will execute a predetermined step or number of steps as described further in FIGS. 7A, 7B, 8 and 9 to reattempt carrier sensing or cycle through alternate Initialization channels, searching for a channel to transmit on. Otherwise, if carrier sensing determines that no Service Advertiser 120 is transmitting on the Initialization channel, the channel is designated IDLE, and transmission of service advertisements may commence.

The above-mentioned LowRate Initiator devices 110 may be wireless devices, such as Personal Digital Assistants (PDA), cell phones, laptop computers or the like. An Initiator device 110 receives the transmitted service advertisements and determines whether or not to respond to them based on user input requesting additional services or data from the Service Advertiser 120. Thus, the Initiator device 110 is responsible for initiating a request for additional services or data on a given unicast channel with the Service Advertiser 120. Various aspects of the present invention will now be described in greater detail.

Detailed Description of Device Structure

As discussed in the Overview section, in FIG. 1, two Service Advertisers 120 are shown, along with a multiplicity of Initiator devices 110. Each Service Advertiser 120 is capable of establishing an active short range wireless connection with one or more Initiator devices 110. The dotted circles 130 shown in FIG. 1 represent Service Advertiser 120 transmissions, as it advertises its ability to provide further data or a service pertaining to a particular subject. The Service Advertiser 120 is capable of transmitting different types of message packets for reception by the Initiator devices 110.

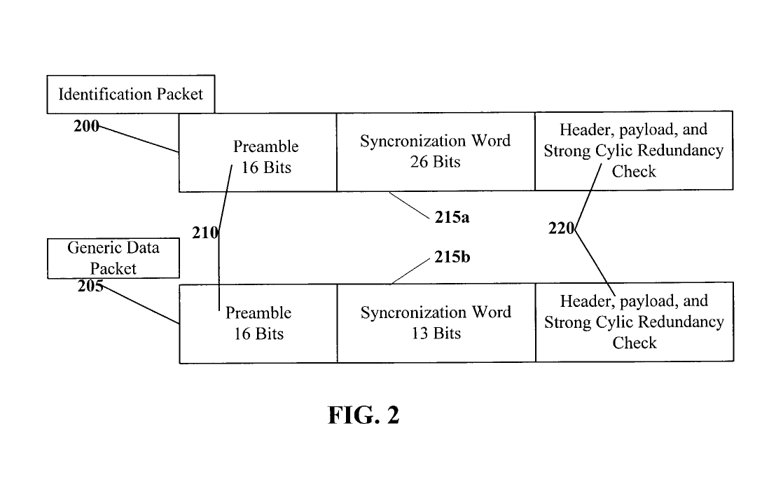

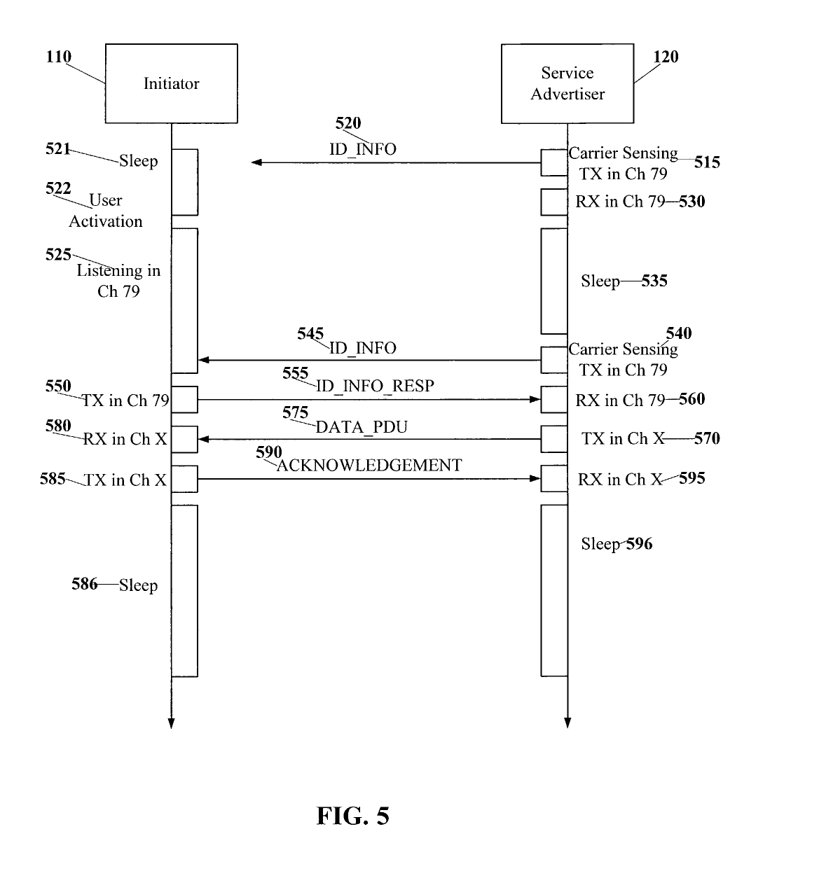

FIG. 2 illustrates two exemplary message packets for use in one embodiment of the present invention. The two message packets in FIG. 2 are an identification message (packet) 200 and a generic data message (packet) 205, as will be described in detail hereinafter. The identification message 200 comprises a 16-bit preamble 210, a 26-bit synchronization word 215a, and a section designated for header, payload and strong cyclic redundancy check data 220. The identification message also includes the address of the device that transmits the message. In one embodiment, Service Advertisers 120 use the identification message 200 to advertise the availability of additional data and services to Initiator devices 110. An Initiator device 110 will respond by transmitting an identification response message specifying the unicast data transfer and service provider channel (“unicast channel”) that it has designated for data transfer. The transmission of these messages during operation is detailed further in FIG. 5. Upon receipt of the response, the Service Advertiser 120 shifts to the unicast channel specified in the identification response message by the Initiator device 110. Service Advertiser 120 provides the additional data or services on the unicast channel using the generic data message packet 205 shown in FIG. 2. The generic data message 205 includes the same 16-bit preamble 210 as the identification message 200, but utilizes a 13-bit synchronization word 215b, rather than a 26-bit synchronization word 215a. A header, payload and strong cyclic redundancy check 220 are also included in the generic data message.

The 16-bit preamble and the difference in synchronization word lengths of the LowRate message packet formats illustrate design tradeoffs between network throughput and device complexity/power consumption. The standard Bluetooth 1.1 packet format uses a 4-bit preamble, which has been optimized for more efficient network performance in regard to transmission of special data such as voice or streaming video. In order to resolve the transmitted preamble value in a Bluetooth implementation, it is necessary to use a large advanced digital DC estimator, thereby increasing the complexity and power consumption associated with Bluetooth devices. In contrast, a LowRate device uses a 16-bit preamble 210 that can be resolved using an analog DC estimator, which consumes less power. The Initiator Device 110 uses the preamble 210 to perform frequency synchronization, symbol timing estimation, and Automatic Gain Control (AGC) training.

The 13-bit synchronization word 215b of the generic data message and the 26-bit synchronization word 215a of the identification message are implemented using one or two consecutive 13-bit Barker codes, respectively. In the 26-bit synchronization word 215a, the second Barker code is the inverse of the first Barker code. The difference in the synchronization words reflects the different purposes for which each is used. The longer synchronization word 215a of the identification message 200 minimizes the probability of false synchronization, wherein random noise is incorrectly identified by the system as a synchronization word. Because the synchronization word 215b used in the generic data message 205 is used for device-to-device synchronization, the length of the synchronization word 215b may be shorter. Strong Cyclic Redundancy Check 220 also provides a method of stopping a false synchronization match as will be discussed in further detail below.

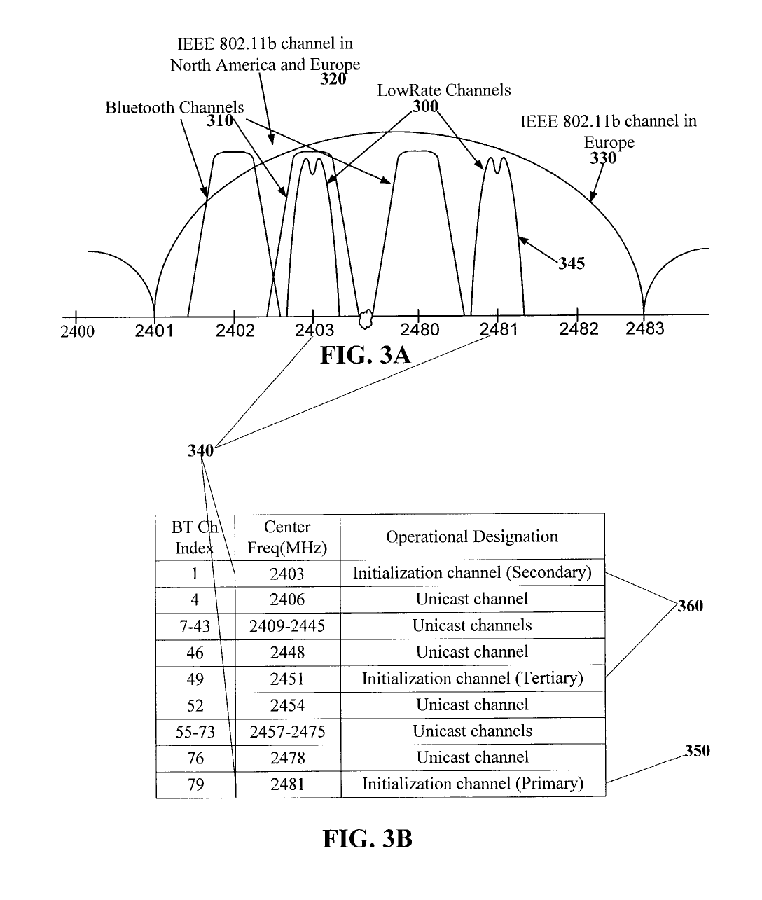

As illustrated in FIG. 3A, in one embodiment of the present invention, the LowRate protocol message transmission occurs on a similar operating frequency band as current Bluetooth systems. The Bluetooth 1.1 specification defines the use of radio frequency channels in the 2400-2483.5 MHz band with center frequencies ranging from 2402+k*1 MHz, where k=0 . . . 78,310. In the embodiment shown in FIG. 3A, the LowRate protocol operating frequency range of 2403 MHz through 2481 MHz is divided into twenty-seven channels, wherein each channel is 3 MHz wide. The implementation of the LowRate protocol at these operating frequencies allows for the LowRate protocol to be incorporated on a device that also has an existing Bluetooth System capability.

FIG. 3B is a table illustrating an exemplary assignment of operating channels in one embodiment of the present invention. In the embodiment shown in FIG. 3B, the LowRate protocol channels are divided into Initialization channels and Unicast channels. An Initialization channel is used to transmit identification messages 200 and to make the initial contact between Service Advertisers 120 and Initiator devices 110. In contrast, a unicast channel is used to transmit generic data messages 205, which contain information such as the additional data or services requested by the Initiator device 110 or, alternatively, the Initiator device's 110 response to receipt of such additional data or services. In accordance with one embodiment of the present invention, a LowRate device—either Service Advertiser 120 or Initiator device 110—may employ the frequency channels set forth in FIG. 3B to transmit identification or generic data messages.

Two of the benefits gained by using these operating frequencies relate to reduced interference on the Initialization channels. The outermost channels used by the LowRate devices are located at 2403 MHz and 2481 MHz 340. These channels are near the minimum of the power spectrum used for IEEE 802.11b WLAN transmissions 320, 330. Consequently, the interference with LowRate transmissions due to IEEE 802.11b WLAN transmissions is minimized. A second advantage relates to the primary Initialization channel. As will be discussed hereinafter, more than one channel may be designated as an Initialization channel and one of the plurality may be a default or primary Initialization channel. In the embodiment illustrated in FIG. 3B, the 2481 MHz channel 345 is selected as the primary Initialization channel used for transmitting service advertisements to avoid any co-channel interference between it and any of the Bluetooth channels.

As further shown in FIG. 3B, three channels, one in the lower end, one in the upper end, and one in the middle of the operating spectrum are designated as Initialization channels. In addition to the primary Initialization channel 350 discussed above, secondary and tertiary Initialization channels at 2403 MHz and 2451 MHz 360, respectively, are selected as alternate Initialization channels for use in the event that carrier sensing determines that the primary Initialization channel is BUSY.

More specifically, after designating the primary Initialization channel at the upper end of the operating spectrum (2481 MHz), the secondary Initialization channel is designated at the lower end of the operating spectrum (2403 MHz). The tertiary Initialization channel is then selected at 2451 MHz in the middle of the operating spectrum to separate the Initialization channels as much as possible and to avoid LowRate co-channel interference among LowRate devices and interference from other devices operating in the global unlicensed Industrial Scientific and Medical (ISM) band at 2400-2483.5 MHz. As further illustrated in FIG. 3B, the other twenty-four operating channels are designated as Unicast channels and are used in transmitting the above-described generic data packets in fulfillment of an Initiator device's 110 request for additional data or services. A detailed description of the channel operation in accordance with the present invention will be discussed below in connection with FIG. 5.

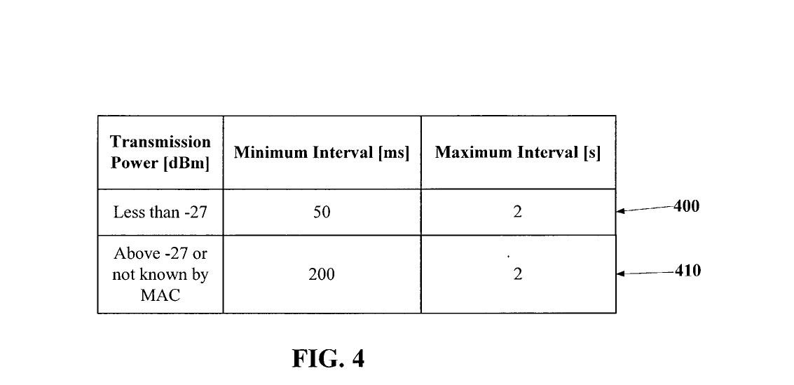

FIG. 4 is a table illustrating an exemplary relationship between the LowRate device transmission power and the transmission frame interval (i.e., the time between transmission frames) for service advertisement transmission frames in an embodiment of the present invention. As indicated in row 400, if a Service Advertiser's 120 transmission power is less than −27 dBm, the range of transmission frame intervals may extend from 50 milliseconds to 2 seconds. Alternatively, as indicated in row 410, if the transmission power is above −27 dBm or if the medium access control layer of the data link layer does not know the transmission power of the device, the range of the transmission frame intervals may extend from 200 milliseconds to 2 seconds.

The transmission frame interval, which is considered to be an application-specific design tradeoff between power consumption and connection speed, may be, but is not limited to, any multiple of the minimum transmission period. Smaller latencies between device transmissions translate into shorter connection setup times. On the other hand, if service advertisements are sent more frequently, the level of power consumed for the additional transmissions also increases. Additionally, the medium access control layer of the data link control layer may add a predetermined hysteresis value to the transmission period, for example ±0.5 ms, in order to expedite recovery time from overlapping service advertisements.

Detailed Description of Operation

One of the design goals of the LowRate protocol involves achieving an implementation with a very low level of power consumption during carrier sensing as compared with typical Bluetooth power consumption levels. Carrier sensing involves measuring the Received Signal Strength Indication (RSSI) on an Initialization channel over a time interval (e.g., 30 usec). The measured value of the RSSI is then compared with a predetermined threshold in order to determine whether the Initialization channel is IDLE (i.e., the measured value is below the threshold and thus the Service Advertiser 120 may transmit); or the channel is BUSY (i.e., the measured value is above the threshold and thus the Service Advertiser 120 may not transmit). The predetermined threshold may be a value less than or equal to an RSSI that would interfere with a Service Advertiser's transmissions (e.g., −60 dBm). The designation BUSY indicates that if a Service Advertiser was to transmit, the transmissions would experience interference from other energy on the channel.

As will be discussed in detail hereinafter, the LowRate protocol's low level of power consumption is achieved through the use of periodic Service Advertiser 120 transmission frames optimized with a random mean zero value offset appended to the start of carrier sensing. Conducting carrier sensing with a random mean zero value offset assists in avoiding transmission collisions, thereby decreasing the level of power consumed during periodic transmissions. The random mean zero value offset allows for Service Advertisers 120 within close proximity of one another, (e.g., the distance within which one Service Advertiser's 120 transmissions could interfere with another Service Advertiser's 120 transmissions) to adjust transmission frames in order to increase the likelihood that carrier sensing will detect a transmission on an Initialization channel and thus avoid collisions. Carrier sensing offsets will be discussed further below in connection with FIGS. 7A, 7B, 8 and 9.

FIG. 5 is an exemplary operation diagram of one embodiment of the present invention, wherein a Service Advertiser 120 attempts advertise services or information to an Initiator device 110 by sending out identification messages during periodic transmission frames. In one embodiment, a transmission frame comprises a set of 5 or 6 different modes that a Service Advertiser 120 will cycle through as will be discussed in detail in connection with FIG. 7A. As shown in FIG. 5, Service Advertiser 120 conducts carrier sensing on the primary Initialization channel and if the channel is IDLE, transitions from the carrier sensing mode to a transmit mode of the transmission frame. (515) During the transmit mode, the Service Advertiser 120 transmits an identification message (“ID_INFO”) on the primary Initialization channel. (520) After transmitting the ID_INFO message, Service Advertiser 120 transitions from the transmit mode into a receive mode of the transmission frame. (530) During the receive mode, the Service Advertiser 120 listens to the initialization channel for a response from an Initiator device 110. If a response is not received, the Service Advertiser 120 switches into a sleep mode of the transmission frame, thereby conserving power for the remainder of the transmission frame. (535) The Service Advertiser 120 sends transmission frames repeatedly in accordance with an application-specific transmission period, such as one of the intervals set forth in FIG. 4.

Similarly, in order to achieve a low level of power consumption, if the user of an Initiator device 110 does not want to receive service advertisements, the user may have the option of placing the Initiator Device 110 into a sleep mode. (521) Accordingly, when in a sleep mode, the Initiator device 110 ignores service advertisements from Service Advertisers 120. The user would then activate Initiator device 110 to receive service advertisements. (522) Upon activation, the Initiator device 110 enters a listening mode on the primary Initialization channel wherein it listens to that channel for service advertisements. (525) Alternatively, in other embodiments, or in embodiments in which power consumption is less of a design concern, the Initiator device 110 may be in an “always-on” listening mode, wherein it always scans an Initialization channel for service advertisements.

As further shown in FIG. 5, having entered a sleep mode, Service Advertiser 120 waits until the start of a new transmission frame, at which time it emerges from the sleep mode to once again conduct carrier sensing on the primary Initialization channel. (540) In the event that the Initialization channel is BUSY during carrier sensing 540, the Service Advertiser 120 repeats carrier sensing a predetermined number of times after a delay (e.g. 1 ms), to expedite connection time with an Initiator device 110. Further, if the Service Advertiser 120 conducts carrier sensing a predetermined number of times and is unable to transmit its ID_INFO 545 message, it may attempt to carrier sense on an alternate Initialization channel.

In the exemplary embodiment shown in FIG. 5, upon determining that the primary Initialization channel is IDLE, Service Advertiser 120 transmits an ID_INFO message to advertise the availability of certain data and services. (545) Having been activated by the user, the Initiator device 110 receives the ID_INFO message from the Service Advertiser 120. Upon receipt, the Initiator device 110 processes the message, and relays the advertised data or services to the user through a user interface such as a display. In the event that the user does not request additional information from the Service Advertiser 120, the Initiator device 110 will return to either a sleep mode or remain active to listen for other service advertisements. In the event, however, that the user desires additional information concerning the services or data being advertised, the Initiator device 110 transmits a response message (“ID_INFO_RESP”) to the Service Advertiser 120 on the initialization channel. (550, 555, 560) The ID_INFO_RESP message, includes the value “X” of a unicast channel selected by the Initiator device 110 for data reception.

Service Advertiser 120 will then transmit the requested data to the Initiator device 110 over the specified unicast channel based on a polling scheme. (570) The process of polling, in general, involves a first device periodically retransmitting a message on a channel until it receives a response from a second device.

After tuning to the unicast channel X, the Service Advertiser 120 periodically transmits a DATA_PDU message to the Initiator device 110 until it receives a response or an application device specific time-out expires while waiting for a response. (570, 575) The DATA_PDU message contains the data related to the advertisements on the Initialization channel. After tuning to channel X, the Initiator device 110 receives the DATA_PDU message (580) and transmits an ACKNOWLEDGEMENT message (generic data message with Acknowledgement information) to Service Advertiser device 120 indicating that the data transfer has been completed and that therefore the wireless connection may be terminated. (585, 590)

After transmitting the ACKNOWLEDGEMENT message, the Initiator device 110 may return to a sleep mode. (596) Alternately, the Initiator device 110 may resume listening on an Initialization channel. Similarly, upon receipt of the ACKNOWLEDGEMENT message the Service Advertiser 120 also may return to a sleep mode. (585, 586) The Service Advertiser 120 remains in a sleep mode until it is once again time to conduct carrier sensing as dictated by the transmission frame interval, at which time the process of FIG. 5 is repeated.

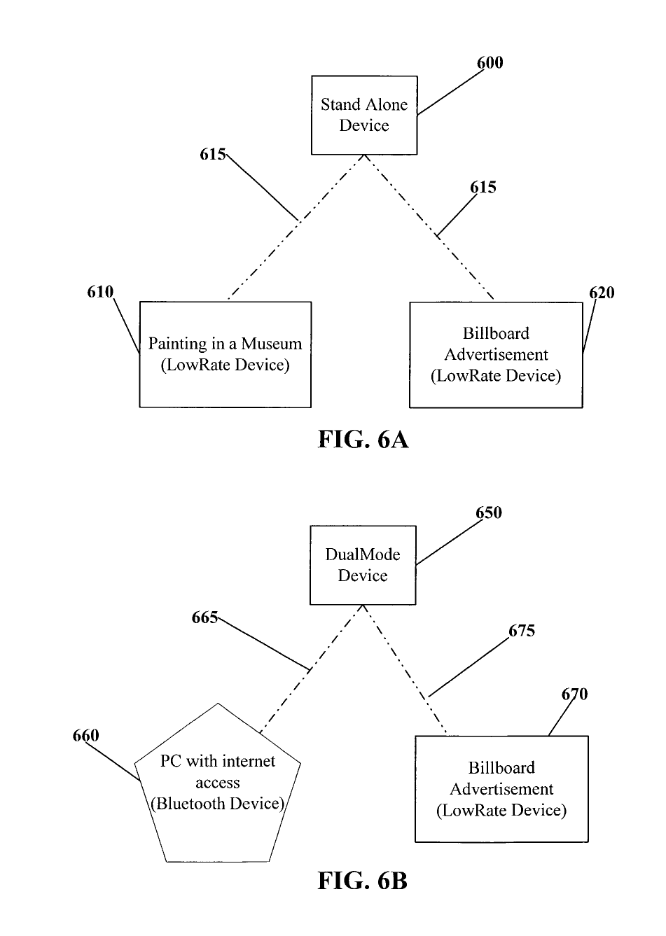

FIG. 6A illustrates an exemplary operation topology for a StandAlone LowRate device 600. In the embodiment illustrated in FIG. 6A, the StandAlone device 600 is capable of conducting short range wireless communications via LowRate connections 615 with other LowRate devices. As shown in FIG. 6A, a connection 615 may be between the StandAlone Low Rate Device 600 and a painting in a museum 610. In the museum application, a Service Advertiser 120 may advertise recorded descriptions of paintings to any Initiator Devices 110 within its coverage area. Alternatively, or in addition thereto, a connection 615 may be between device 600 and a billboard advertisement 620. Other possible LowRate applications may include a food package that transmits a URL address detailing nutritional information to an Initiator device 110, a lock that communicates with a digital key or a lamp that communicates with a LowRate enabled Personal Digital Assistant. In short, StandAlone devices 600 may be everyday consumer devices for which low power consumption is an important design parameter.

FIG. 6B illustrates an exemplary operation topology of a DualMode LowRate device 650. The DualMode device 650 includes both a LowRate protocol capability and another short-range wireless capability such as Bluetooth. Thus, the DualMode device 650 can establish a LowRate connection 675 with, e.g., a billboard advertisement, as discussed above in connection with FIG. 5. However, the DualMode device 650 is also capable of establishing a Bluetooth connection 665 with a device 660 such as a Bluetooth enabled personal computer having an internet access capability. DualMode devices 650 are typically not as concerned with power consumption due to the existing Bluetooth system power requirements, which are significantly greater than the level of power consumption associated with a LowRate device.

FIG. 7A illustrates an exemplary use of a random mean zero value offset with carrier sensing when a first Service Advertiser 705 offsets its transmission frame later in time from an application-specific transmission interval 720 and its transmission is detected by a second Service Advertiser 701 in one embodiment of the present invention.

A timeline 710 with an arrow indicating the direction of increasing time is shown in FIG. 7A. Service Advertiser LowRate devices 701-705 are shown in FIG. 7A as transmitting service advertisements over time. The Service Advertisers 701-705 are within a specified proximity of one another such that the carrier sensing of Service Advertiser 701 would recognize the transmissions of any of the other Service Advertisers 702-705, should the transmit modes overlap in time.

As shown in FIG. 7A, an exemplary format of a transmission frame 730 includes five modes of operation: carrier sensing mode 715, first switching mode 731, transmission mode 732, second switching mode 733, and reception mode 734. If carrier sensing determines that the Initialization Channel is IDLE, a Service Advertiser enters the first switching mode 731, as it prepares to enter the third mode of operation, the transmission mode 732. During the transmission mode 732, a Service Advertiser transmits the identification message ID_INFO 545 to advertise that additional information or specific services are available. The Service Advertiser enters a second switching mode 733 after the ID_INFO message is sent 545, as it switches between transmission and reception modes. During the reception mode 735, the Service Advertiser listens for the message ID_INFO_RESP 560 on the Initialization channel as transmitted by an Initiator device 110 to request services or additional data from the Service Advertiser. The Service Advertiser may enter a sixth mode—namely, a sleep mode, if there is time remaining before the next transmission frame is scheduled.

In order for carrier sensing to be an effective method of avoiding collisions, a first Service Advertiser should conduct carrier sensing at a different time than a second advertiser, preferably while the second Service Advertiser is transmitting. In this event, the carrier sensing will detect a level of energy associated with a transmission as being, e.g., above a predetermined threshold and execute a predetermined action or set of actions in accordance with one embodiment of the present invention. Such actions may involve either executing the next mode of the transmission frame, reattempting carrier sensing, tuning to an alternate Initialization channel or any combination thereof. However, if a first Service Advertiser conducts carrier sensing at the same instant in time that a second Service Advertiser conducts carrier sensing, or is otherwise preparing to transmit, the Initialization channel will be IDLE during both carrier sensing periods, and thus, neither of the Service Advertisers will recognize that the other is transmitting. Consequently, their transmissions will result in collisions, the loss of the transmitted data, and thus unnecessary power consumption.

In order to increase the likelihood that devices with similar transmission frames will recognize each other's transmissions, an offset with a random mean zero value is incorporated into the time associated with the start of carrier sensing as will be discussed in detail hereinafter. Each Service Advertiser incorporates the random mean zero value offset into the timing of carrier sensing at the start of a transmission frame. The random mean zero value offset, as shown with regard to reference numeral 740 in FIG. 7A, illustrates that a Service Advertiser can shift its transmission frame later in time, with respect to a predetermined application-specific transmission frame interval to achieve a random mean zero value offset that avoids collisions. Alternatively, as shown in FIG. 7B, a Service Advertiser 754 can shift its transmission frame earlier in time as shown by random mean zero value offset 790. In one embodiment the offset time is selected from a random distribution of values derived from a fraction of the length of time that it takes for a device to switch between the transmission and reception modes. Alternately, the distribution of values may be derived from other device-specific timing characteristics or empirical data.

It is also to be understood that the illustrations of FIGS. 5, 7A, 7B, 8, and 9 and descriptions thereof, for the sake of illustrating functionality associated with carrier sensing, assume that the only energy on the operating band is being transmitted by the illustrated Service Advertisers. In a real world environment, carrier sensing acts to measure the RSSI, detecting various emissions at a given the frequency, regardless of the sources of the emissions. In some instances it is possible for LowRate channels to become congested or jammed by various other devices that transmit in the LowRate operating frequency spectrum such as microwave ovens, cordless telephones, or the transmissions of WLAN or Bluetooth devices.

In a first exemplary case illustrated in FIG. 7A, Service Advertisers 701 and 702 have periods of carrier sensing 715, 716 that start 720 and end 721 at the same time. Accordingly, both devices will measure the Received Signal Strength Indication (RSSI) on the primary Initialization channel and determine that it is IDLE. After determining that the primary Initialization channel is IDLE, both Service Advertisers 701, 702 will attempt to transmit on it, resulting in transmission collisions.

With respect to Service Advertisers 703 and 704, even though the periods of carrier sensing 717, 718 implement random mean zero value offsets from Service Advertiser 701, both periods of carrier sensing will indicate that the channel is IDLE, because no LowRate device is transmitting on an Initialization channel during those periods of carrier sensing. Consequently, the resulting transmissions of Service Advertisers 703 and 704, like those of Service Advertiser 701 and 702, will also experience collisions.

In contrast, the period of carrier sensing 719 associated with Service Advertiser 705, which starts at time 722 incorporates a random mean zero value offset indicated by reference numeral 740. Carrier sensing 719 coincides with the start of the transmission period of Service Advertiser 701, and ends at time 723. Carrier sensing 719 will result in Service Advertiser 705 recognizing that Service Advertiser 701 is transmitting on the Initialization channel and determining that the Initialization channel is therefore BUSY. Consequently, Service Advertiser 705 will delay its transmission frame in time to avoid a collision.

FIG. 7B illustrates an exemplary use of random mean zero value offsets with carrier sensing when a first Service Advertiser 751 with an application-specific transmission frame interval detects a second Service Advertiser 754 which has offset its transmission frame interval earlier in time as indicated by reference numeral 790 in an embodiment of the present invention. As in the embodiment of FIG. 7A, the Service Advertisers 751-754 are within a specified proximity of one another, such that the carrier sensing of Service Advertiser 751 would recognize the transmissions of any of the other Service Advertisers (752, 753, 754) in the event that the transmissions overlap in time. In the embodiment of FIG. 7B, Service Advertiser 754 incorporates a random mean zero value offset indicated by reference numeral 790 and conducts carrier sensing 765 at time 770 and thus, will be the first of the four devices 751-754 to transmit on the primary Initialization channel. After measuring the RSSI on the primary Initialization channel during carrier sensing, Service Advertiser 754 determines that the channel is IDLE. The transmission frame associated with Service Advertiser 754 is followed sequentially by transmission frames corresponding to Service Advertisers 753, 752, and 751, respectively. Service Advertiser 752 and Service Advertiser 753 conduct carrier sensing while Service Advertiser 754 is in switching mode 766 preparing to transmit. Consequently, both devices will incorrectly determine that the Initialization channel is IDLE and attempt to transmit, leading to transmission collisions between Service Advertisers 754, 753, and ultimately with Service Advertiser 752.

Service Advertiser 751 conducts carrier sensing 780 at time 771, which occurs just after Service Advertiser 754 has started to transmit at time 771. Accordingly, Service Advertiser 751 will detect that Service Advertiser 754 has begun transmitting, and determine that the primary Initialization channel is BUSY. Service Advertiser 751 will then delay its transmission frame in time to avoid a collision.

In summary, FIGS. 7A and 7B illustrate that transmission collisions may be avoided by implementing a random mean zero value offset that shifts the transmission frame of Service Advertisers either later or earlier in time to increase the likelihood that a Service Advertiser's carrier sensing will effectively recognize the transmissions of another Service Advertiser.

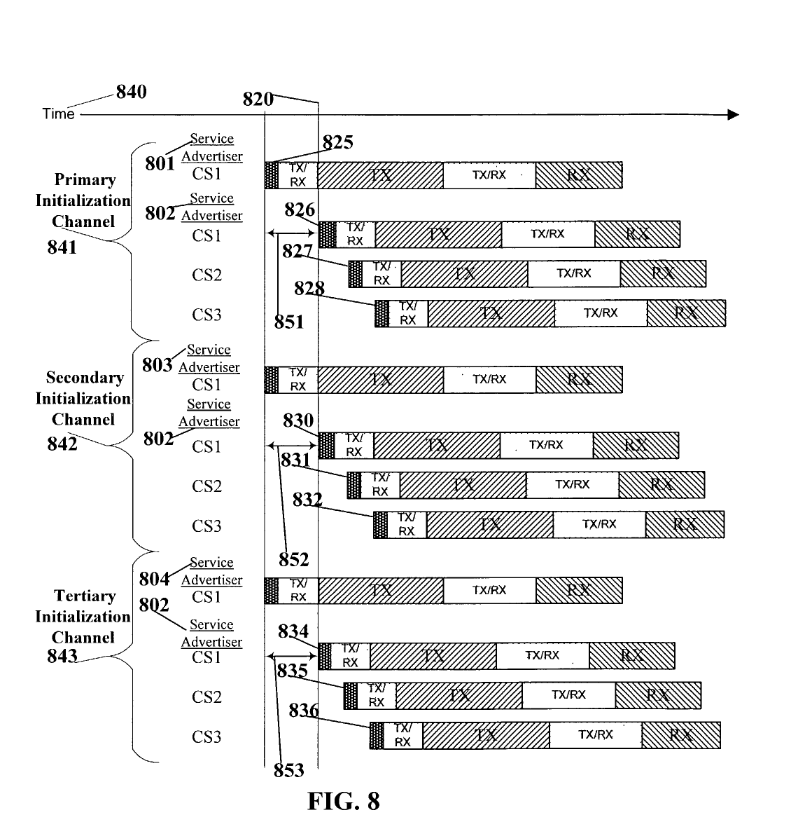

FIG. 8 illustrates an exemplary use of a random mean zero value offset with carrier sensing in which a second Service Advertiser 802 detects a first Service Advertiser 801 by implementing a random mean zero value offset 851, which offsets the second Service Advertiser's transmission frame later in time from an application-specific transmission frame interval. The second Service Advertiser 802 upon designating the primary Initialization channel 841 as BUSY, in turn, cycles through alternate Initialization channels attempting to find an IDLE channel. The random mean zero value offset 851 is shown in FIG. 8 is the difference in time between the start of carrier sensing periods 825 and 826. In one embodiment, a Service Advertiser may bypass a congested Initialization channel, by switching to a secondary Initialization channel (such as the one shown in FIG. 3B) in the event that a predetermined number of attempted transmissions (e.g., three) on the primary Initialization channel are unsuccessful.

As illustrated in FIG. 8, a timeline 840 indicates the direction of increasing time. Service Advertiser 801 conducts carrier sensing as specified by reference numeral 825 and prepares to transmit on primary Initialization channel 841 at time 820. Service Advertiser 802 conducts carrier sensing 826 offset in time by a random mean zero value 851, after Service Advertiser 801 has begun to transmit. Consequently, Service Advertiser 802 will detect that Service Advertiser 801 is transmitting on the primary Initialization channel 841 and after a predetermined delay will repeat carrier sensing a second and a third time (827, 828), each time, however, determining that the primary Initialization channel 841 is BUSY. In the embodiment of FIG. 8, Service Advertiser 802 may then tune to the secondary Initialization channel 842 in an attempt to establish a communication link with an Initiator device 110 that is actively listening for service advertisements on the secondary Initialization channel.

As further shown in FIG. 8, after conducting carries sensing on the second Initialization channel offset by a random mean zero value 852, Service Advertiser 802 may find that Service Advertiser 803 is already transmitting on that channel. Service Advertiser 802 will then reattempt carrier sensing (831, 832) after a predetermined delay and again determines that the channel is BUSY. Service Advertiser 802 may tune to yet a tertiary Initialization channel 843 and again reattempt a transmission. After conducting carrier sensing (834, 835, 836) initially offset by a value 853 during a time period when Service Advertiser 804 is transmitting, Service Advertiser 802 concludes that the tertiary Initialization channel 843 is also BUSY. Service Advertiser 802 will then cycle back to the primary Initialization channel 841 and reattempt carrier sensing on that channel. If the channel 841 is determined to be BUSY, Service Advertiser 802 will continue to cycle through the alternate Initialization channels 842 and 843 until an Initialization channel is determined by carrier sensing to be IDLE, at which time the Service Advertiser 802 may begin transmitting.

It is to be understood that the predetermined number of Initialization channels may vary by application and that different cycling schemes may be implemented. Additionally, it is to be understood that the number of attempts of carrier sensing executed on an initialization channel before reattempting transmission on an alternate initialization channel may vary. Moreover, the random mean zero offset is generated from a distribution of values that may be application or device specific.

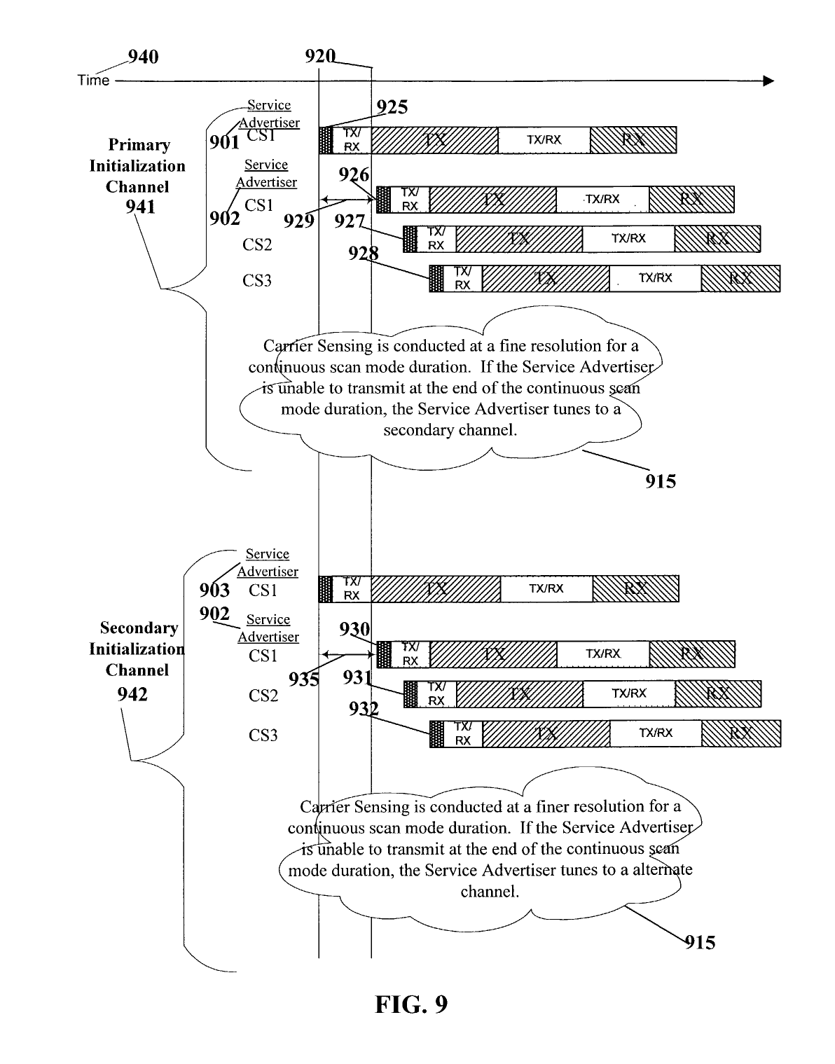

FIG. 9 illustrates an exemplary use of an offset with carrier sensing in which a first Service Advertiser's 901 transmissions are detected by a second Service Advertiser 902 which, in turn, enters a continuous scan mode. Once again, a timeline 940 indicates the direction of increasing time. As shown in FIG. 9, Service Advertiser 901 conducts carrier sensing 925, establishes that the primary Initialization channel 941 is IDLE and begins to transmit at time 920. Service Advertiser 902 repeatedly conducts carrier sensing (926, 927, and 928) initially offset by random mean zero value 929 after Service Advertiser 901 has begun to transmit. After three consecutive BUSY carrier sensing attempts (926, 927, and 928) on the primary Initialization channel Service Advertiser 902 enters a continuous scan mode to increase the likelihood of transmission of its service advertisements.

In the continuous scan mode 915, Service Advertiser 902 conducts carrier sensing repeatedly at a given frequency (e.g. every 1 ms), during a given continuous scan mode duration (e.g. 200 ms). The carrier sensing frequency in continuous scan mode is application-specific. Accordingly, Service Advertiser 902 may implement a carrier sensing frequency that is faster, slower, or the same as that which is illustrated in FIG. 9. Alternatively, the carrier sensing frequency may either start at a low frequency and increase over time or start at a high frequency and decrease over time. If the RSSI measured during carrier sensing drops below the predetermined threshold value, the continuous carrier sensing is interrupted to transmit the message ID_INFO 520. However, if the RSSI does not drop below the threshold value by the completion of a predetermined continuous scan mode duration, the Service Advertiser 902 will tune to a secondary Initialization Channel 942.

Once tuned to the secondary Initialization channel 942, Service Advertiser 902 will conduct carrier sensing (930, 931, and 932) initially offset by a value 935. Upon determining that Service Advertiser 903 is transmitting on the secondary Initialization channel 942, Service Advertiser 902 will again enter the continuous scan mode 903 to conduct carrier sensing at the predetermined carrier sensing frequency. Accordingly, in the event that Service Advertiser 903 completes transmitting and the Initialization channel becomes IDLE within the continuous scan mode duration, Service Advertiser 902 may then transmit its service advertisements. If the end of the continuous scan mode duration is reached without Service Advertiser 902 successfully transmitting a service advertisement, it may tune to yet an alternate channel or tune back to the primary Initialization channel. Upon tuning to another Initialization channel, Service Advertiser 902 will reattempt carrier sensing as discussed above until an opportunity to transmit service advertisements arises.

Error Handling

In the embodiments discussed above, various aspects of error handling may be implemented. One example of error handling implemented in the LowRate protocol involves Strong Cyclic Redundancy Checks. The process of Cyclic Redundancy Checking (CRC) involves examining data that has been transmitted on a communication link for errors that may have occurred during transmission. The sender applies a polynomial to a block of data designated for transmission and appends the resulting cyclic redundancy code to the data block. The receiver applies the same polynomial to the data after reception and compares the result with the appended result. If the two results are the same, the data has been successfully sent. Otherwise, the receiver may send a request to the sender for retransmission of the data block.

Additional error handling may be provided by the Service Advertiser 120. For example, if the Service Advertiser recognizes an increase in the RSSI level or in the event that the synchronization was successful but the Strong Cyclic Redundancy Check failed, the Service Advertiser 120 may temporarily accelerate the transmission frame interval on the Initialization channel in a predetermined manner over a predetermined length of time. In particular, the Service Advertiser 120 may increase the transmission frame interval as discussed above in connection with FIG. 4 from once every 200 ms to once every 100 ms and maintain that transmission frame rate over a one second interval. In the event that a first Service Advertiser 120 receives an ID_INFO message 545 associated with a second Service Advertiser 120, the first Service Advertiser 120 may shift its advertising period to start a predetermined length of time earlier or later (e.g., 0.5 ms earlier) to avoid collisions.

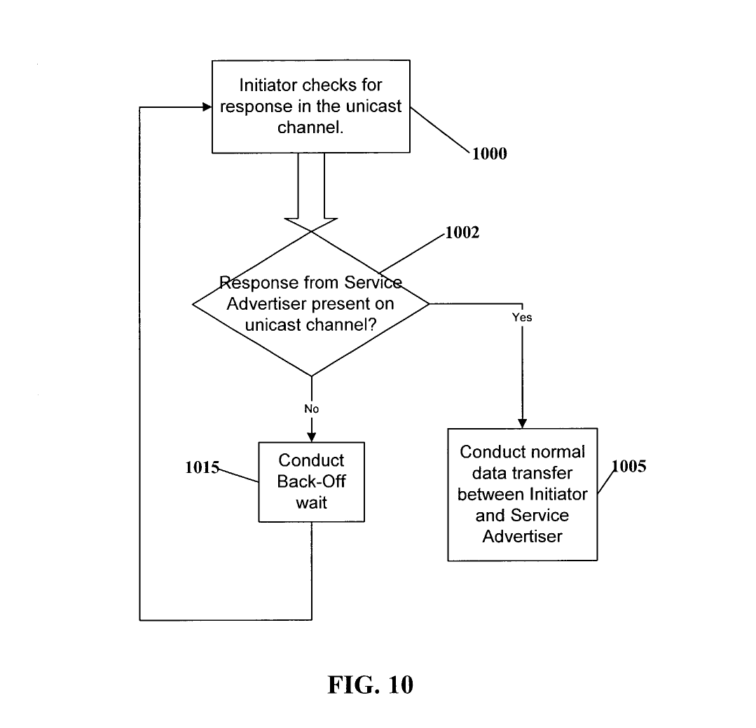

Error handling functionality is not limited to the Service Advertiser 120. The Initiator device 110 may have an active role in recovering from a nonresponse or incorrect response from the Service Advertiser 120 through the use of a Back-Off wait method, which is described in greater detail below in connection with FIG. 10. A nonresponse involves the Service Advertiser 120 sending the ID_INFO message 545 and the Initiator device 110 initiating a communication link by transmitting the ID_INFO_RESP message 560 in an attempt at establishing the data transfer in the unicast channel. Accordingly, the Initiator device 110 tunes to the unicast data transfer channel specified in the ID_INFO_RESP message 560 and waits for the DATA_PDU message 575 from the Service Advertiser 120. As the name of the error implies, a nonresponse indicates that the requested DATA_PDU message 575 is not received by the Initiator device 110.

In contrast, the Initiator device may identify an incorrect response, by determining that two or more Initiator devices 110 initiated a response to the same ID_INFO message 545. The Initiator device 110 identifies an incorrect response through processing the DATA_PDU message 575 and examining the message header for the destination address. If the Initiator device 110 identifies that the DATA_PDU message 575 contains a destination address not equal to its own destination address the response is designated incorrect. Accordingly, the Initiator device 110 will then conduct the Back-Off wait method described below in an attempt to reestablish a communication link with the Service Advertiser 120.

FIG. 10 is a flow chart illustrating an exemplary method by which collision handling may be performed by an Initiator device in accordance with one embodiment of the present invention. In step 1000, after the Initiator Device 110 transmits an ID_INFO_RESP message, it tunes to the designated unicast channel and waits for the Service Advertiser 120 to transmit the DATA_PDU message. In step 1002, the Initiator Device executes certain events based on whether or not the DATA_PDU message is received on the unicast channel. In the event that the DATA_PDU message is received, the normal data transfer between Initiator device 110 and Service Advertiser 120 occurs in step 1005. If, however, the response is not received or is incorrect (wherein, as discussed above, an incorrect response involves a first Initiator device processing a service advertisement with a destination address corresponding to a second Initiator device), the Initiator device 110 executes a Back-Off wait in step 1015. A Back-Off wait comprises selecting a random number x from an initial range and waiting x time periods before reattempting to receive a response from the Service Advertiser 120, as shown in step 1000. In one embodiment, the initial selection range of wait time periods may extend from 1 to 2\hat{ }(n+1) with n initialized to 1. The variable n represents the nth iteration through the Back-Off wait loop (i.e., steps 1000, 1002, 1015). Incrementing the variable n after successive iterations without receiving a response effectively increases the upper bound of the random number selection range. After selecting a value for x, the device 110 may wait x time periods before reattempting to receive a response from the Service Advertiser 120. The time periods, for example, may be derived from either the length of a full transmission frame from the Service Advertiser 120, the time associated with transmission/reception switching modes, other system specific times, or some arbitrary time values. The method for determining the selection range may take other forms in different embodiments. For instance, the Back-Off selection range may be increased linearly, exponentially, or it may be implemented from some other mathematical formula optimized for a specific application.

The many features and advantages of the present invention are apparent from the detailed specification, and thus, it is intended by the appended claims to cover all such features and advantages of the invention which fall within the true spirit and scope of the invention.

Furthermore, since numerous modifications and variations will readily occur to those skilled in the art, it is not denied that the present invention be limited to the exact construction and operation illustrated and described herein, and accordingly, all suitable modifications and equivalents which may be resorted to are intended to fall within the scope of the claims.

We claim:

1. A method for implementing a short range wireless communication system, comprising:
measuring an energy level on an initialization channel at a beginning of a periodic transmission interval; and
comparing a measured value of the energy level to a predefined transmission threshold value to determine whether to transmit a periodic advertisement message on the initialization channel.

2. The method of claim 1, further comprising the step of:
transmitting the periodic advertisement message on the initialization channel if the measured value of the energy level is below the predefined threshold value.

3. The method of claim 1, further comprising the step of:
repeating the measuring of the energy level on the initialization channel after a predefined offset time period if the measured value of the energy level is above the predefined threshold value.

4. The method of claim 1, wherein said periodic transmission interval is a predefined time interval for transmitting the periodic advertisement message on the initialization channel.

5. The method of claim 4, wherein the predefined time interval is preceded by a random mean zero value offset time.

6. The method of claim 5, wherein the random mean zero value offset time has a maximum value substantially equal to a first switching time for preparing the transmission of the periodic advertisement message.

7. The method of claim 1, wherein the step of measuring the energy level on the initialization channel comprises conducting carrier sensing on said initialization channel.

8. The method of claim 7, wherein the carrier sensing comprises Carrier Sensing Multiple Access with Collision Avoidance and Frequency Division Multiple Access schemes.

9. The method of claim 3, further comprising the steps of:
transmitting the periodic advertisement message on the initialization channel if the measured value of the energy level is below the predefined threshold value; and
repeating the measuring of the energy level on the initialization channel after a predefined offset time period if the measured value of the energy level is above the predefined threshold value.

10. The method of claim 9, further comprising the step of:
changing to an alternate initialization channel if the measured value of the energy level is above the predefined threshold value.

11. The method of claim 10, further comprising the steps of:
measuring an energy level on the alternate initialization channel at a beginning of a periodic transmission interval on the alternate initialization channel; and
comparing a measured value of the energy level to a predefined transmission threshold value to determine whether to transmit the periodic advertisement message on the alternate initialization channel.

12. The method of claim 11, further comprising the steps of:
transmitting the periodic advertisement message on the alternate initialization channel if the measured value of the energy level is below the predefined threshold value; and
repeating the measuring of the energy level on the alternate initialization channel after a predefined offset time period if the measured value of the energy level is above the predefined threshold value.

13. A method for a short range wireless device to communicate on a communication link comprising:
establishing a communication link on an initialization channel;
tuning from an initialization channel to a unicast channel; and
reestablishing the communication link on the initialization channel in the event of a data transmission error on the unicast channel, wherein said reestablishing comprises:
selecting a random number from an initial range of values, said random number corresponding to a number of wait time periods a receiving device will wait before attempting to reestablish a connection;
waiting for a length of time equal to the number of wait time periods; and
in the event that the receiving device, after waiting said length of time, does not receive an expected transmission, increasing an upper bound of the initial range.

14. The method of claim 13 wherein the expected transmission comprises additional data and/or services specified in an initial transmission.

15. The method of claim 13 wherein the data transmission error involves a nonresponse.

16. The method of claim 13 wherein the data transmission error involves a incorrect response.

17. The method of claim 13 further comprising reselecting a value and increasing the upper bound repeatedly until the receiving device receives the expected transmission.

18. The method of claim 13, wherein said upper bound is increased exponentially.

19. The method of claim 13, wherein said upper bound is increased linearly.

20. A system implementing short range wireless communication, comprising:
a memory having program code stored therein;
a processor operatively connected to said memory for carrying out instructions in accordance with said stored program code;
wherein said program code, when executed by said processor, causes said processor to:
measure an energy level on an initialization channel at a a beginning of a periodic transmission interval; and
compare a measured value of the energy level to a predefined transmission threshold value to determine whether to transmit a periodic advertisement message on the initialization channel.

21. The system of claim 20 wherein said program code causes said processor to:
transmit the periodic advertisement message on the initialization channel if the measured value of the energy level is below the predefined threshold value.

22. The system of claim 20, wherein said program code causes said processor to:
repeat measuring the energy level on the initialization channel after a predefined offset time period if the measured value of the energy level is above the predefined threshold value.

23. The system of claim 20, wherein said program code causes said processor to implement said periodic transmission interval as a predefined time interval for transmitting the periodic advertisement message on the initialization channel.

24. The system of claim 23, wherein said program code causes said processor to:
precede the predefined time interval with a random mean zero value offset time.

25. The system of claim 24, wherein said program code causes said processor to:
set the random mean zero value offset time with a maximum value substantially equal to a first switching time for preparing the transmission of the periodic advertisement message.

26. The system of claim 23 wherein said program code causes said processor to:
transmit the periodic advertisement message on the initialization channel if the measured value of the energy level is below the predefined threshold value; and
repeat the measurement of the energy level on the initialization channel after a predefined offset time period if the measured value of the energy level is above the predefined threshold value.

27. The system of claim 26, wherein said program code causes said processor to:
tune to an alternate initialization channel if the measured value of the energy level is above the predefined threshold value.

28. The system of claim 27, wherein said program code causes said processor to:
measure an energy level on the alternate initialization channel at a beginning of a periodic transmission interval on the alternate initialization channel; and
compare a measured value of the energy level to a predefined transmission threshold value to determine whether to transmit the periodic advertisement message on the alternate initialization channel.

29. The system of claim 28, wherein said program code causes said processor to:
transmit the periodic advertisement message on the alternate initialization channel if the measured value of the energy level is below the predefined threshold value; and
repeat the measurement of the energy level on the alternate initialization channel after a predefined offset time period if the measured value of the energy level is above the predefined threshold value.

30. A short range wireless device for communicating on a communication link comprising:
a memory having program code stored therein;
a processor operatively connected to said memory for carrying out instructions in accordance with said stored program code;
wherein said program code, when executed by said processor, causes said processor to:
establish a communication link on an initialization channel;
tune from an initialization channel to a unicast channel; and
reestablish the communication link on the initialization channel in the event of a data transmission error on the unicast channel, wherein said reestablishing comprises:
selecting a random number from an initial range of wait values, said random number corresponding to a number of wait time periods a receiving device will wait before attempting to reestablish a connection;
waiting for a length of time equal to the number of wait time periods; and
in the event that the receiving device after waiting said length of time, does not receive an expected transmission, increasing an upper bound of the initial range.

31. The system in claim 30 wherein said program code causes said processor to:
reselect a value; and
increase the upper bound repeatedly until the receiving device receives the expected transmission.

32. A computer-readable medium having computer-executable instructions for performing a method for implementing a short range wireless communication system comprising:
measuring an energy level on an initialization channel at a beginning of a periodic transmission interval; and
comparing a measured value of the energy level to a predefined transmission threshold value to determine whether to transmit a periodic advertisement message on the initialization channel.

33. The computer-readable medium of claim 32 further comprising transmission of the periodic advertisement message on the initialization channel if the measured value of the energy level is below the predefined threshold value.

34. The computer-readable medium of claim 32 further comprising:
repeating measuring the energy level on the initialization channel after a predefined offset time period if the measured value of the energy level is above the predefined threshold value.

35. The computer-readable medium of claim 32 wherein said periodic transmission interval is a predefined time interval for transmitting the periodic advertisement message on the initialization channel.

36. The computer-readable medium of claim 35 further comprising:
preceding the predefined time interval with a random mean zero value offset time.

37. The computer-readable medium of claim 36, further comprising:
setting the random mean zero value offset time with a maximum value substantially equal to a first switching time for preparing the transmission of the periodic advertisement message.

38. The computer-readable medium of claim 35 further comprising:
transmitting the periodic advertisement message on the initialization channel if the measured value of the energy level is below the predefined threshold value; and
repeating the measurement of the energy level on the initialization channel after a predefined offset time period if the measured value of the energy level is above the predefined threshold value.

39. The computer-readable medium of claim 26, further comprising:
tuning to an alternate initialization channel if the measured value of the energy level is above the predefined threshold value.

40. The computer-readable medium of claim 39, further comprising
measuring an energy level on the alternate initialization channel at a beginning of a periodic transmission interval on the alternate initialization channel; and
comparing a measured value of the energy level to a predefined transmission threshold value to determine whether to transmit the periodic advertisement message on the alternate initialization channel.

41. The computer-readable medium of claim 40, further comprising:
transmitting the periodic advertisement message on the alternate initialization channel if the measured value of the energy level is below the predefined threshold value; and
repeating the measurement of the energy level on the alternate initialization channel after a predefined offset time period if the measured value of the energy level is above the predefined threshold value.

42. A computer-readable medium having computer-executable instructions for performing a method for implementing a short range wireless communication system comprising:
establishing a communication link on an initialization channel;
tuning from an initialization channel to a unicast channel; and
reestablishing the communication link on the initialization channel in the event of a data transmission error on the unicast channel, wherein said reestablishing comprises:
selecting a random number from an initial range of wait values, said random number corresponding to a number of wait time periods a receiving device will wait before attempting to reestablish a connection;
waiting for a length of time equal to the number of wait time periods; and
in the event that the receiving device after waiting said length of time, does not receive an expected transmission, increasing an upper bound of the initial range.

43. The computer-readable medium of claim 42 further comprising:
reselecting a value; and
increasing the upper bound repeatedly until the receiving device receives the expected transmission.
